(19) United States
(12) Patent Application Publication
(10) Pub. No.: US 2013/0136576 A1
(43) Pub. Date: May 30, 2013

(54) WIND TURBINE AIR FLOW GUIDE DEVICE

(71) Applicant: Sebastian Wojnar, Brighton East (AU)

(72) Inventor: Sebastian Wojnar, Brighton East (AU)

(73) Assignee: Sebastian Wojnar, Brighton East, VI (AU)

(21) Appl. No.: 13/807,437

(22) PCT Filed: Jun. 30, 2011
(86) PCT No.: PCT/AU2011/000811

§ 371 Date: Feb. 5, 2013

(30) Foreign Application Priority Data
Jun. 30, 2010 (AU) 2010902917

(51) Int. Cl. F03D 1/04; F03D 3/04

(52) U.S. Cl. CPC F03D 1/04; F03D 3/0427
USPC 415/1; 415/183

(57) ABSTRACT

The invention extends to an air flow device for wind turbines which includes a number of flow paths which assist in the movement of air through the air flow device which assists in increasing the efficiency and power output of the wind turbine. The air flow device includes flow passages alongside a central channel which houses the wind turbine.

### FIELD OF THE INVENTION

The invention generally relates to an air flow device and more particularly is concerned with an air flow device for use with a wind turbine.

Whilst the invention may be applied to any type of wind turbine, for convenience sake it shall be described herein in terms of an air flow device for use with wind turbines such as vertical axis wind turbines (VAWT).

### BACKGROUND TO THE INVENTION

Generally the power output of a wind turbine is dependent on the velocity with which air flows past the wind turbine. In other words, greater air speeds normally allow wind turbines to generate more electricity. However, wind turbines often have to operate in low wind speed conditions which reduce the efficiency of the wind turbine.

A number of solutions have been devised in the past to allow wind turbines, normally having horizontal axes (hereinafter referred to as HAWT), to operate more efficiently at low ambient wind speed conditions.

For example, United States patent publication No. 2009/0295164 teaches the use of one or more flow surfaces to guide wind up towards and/or out from a rotor of a wind turbine so that a venturi effect is established which allows the wind turbine to operate at lower wind speeds. However, this solution suffers from a number of difficulties including requiring a complex operating system making use of hydraulics which may be operated remotely. Also, a number of separate components are required and which may be difficult to install and to correctly align in order to achieve the venturi effect. Additionally, the method of this invention requires the measurement of the speed and direction of wind in order to determine the placement and direction of the wind flow surface relative to the wind turbine. This can be time-consuming and cumbersome. Furthermore, the operation of the apparatus of this invention has a dependency on the wind speed in that adjustments are to be made to the angles of the flow surfaces at high wind speeds.

In another example, U.S. Pat. No. 7,354,245 teaches a device for use with a HAWT with the primary aim of improving rotational efficiency of the wind turbine. The device includes a duct which has a side wall which produces a reduced pressure area at the rear of the duct thereby to prevent generation of a swirl at the end of the duct. The invention of this US patent is therefore primarily concerned with improving rotational efficiency of a horizontal axis rotor of the HAWT by diverting air down two ducts rather than just one. This reduces turbulence in the outlet caused by the rotation of the horizontal axis rotor. In other words, this device is aimed at reducing turbulence specifically for HAWT's. Additionally, increased wind speed achieved by the device is achieved as a result of a low pressure region at the outlet which is established through the design of the duct, and not merely as a result of the Venturi effect. Consequently, the diffuser, or region after the horizontal axis rotor, is substantially longer than the inlet portion before the horizontal axis rotor.

Since air is taken to be a fluid, the concept of pressure is central when considering the pressure dynamics of a fluid system such as airflow through a wind turbine. In fluid dynamics, often Bernoulli's equation is taken to be fundamental to the dynamics of incompressible fluids. In many fluid flow situations of interest, one school of thought sees changes in density being insignificant and therefore allowing such changes to be ignored. With this simplification, Bernoulli's equation for incompressible flows can be expressed as:

$$P + \frac{1}{2} ρ {υ}^{2} = {P}_{0} ,$$

where:
P indicates static pressure,
½ρν² indicates dynamic pressure, usually denoted by q,
ρ reflects the density of the fluid,
ν reflects flow velocity, and
P₀ indicates total pressure of the system which is constant along any streamline.

Any reference to publications in the specification is not an admission that the disclosures constitute common general knowledge in Australia.

### SUMMARY OF THE INVENTION

Accordingly, it is an object of the present invention to at least partly overcome or ameliorate at least one of the disadvantages of the prior art.

In a first form, the present invention provides a wind turbine air flow device when used devices the flow of air relative to a wind turbine; the wind turbine air flow device includes a body having a side wall which defines a channel which extends through the body; and the at least one side wall having an inlet portion which defines an inlet to the channel, an outlet portion which defines an outlet from the channel, and an intermediate portion which lies between the inlet and outlet portions inside the channel; wherein the inlet portion has at least one guide vane so that the channel at the inlet portion is divided into a number of flow paths leading towards the wind turbine; wherein in use the wind turbine is positioned inside the intermediate portion so that air passing through the channel from the inlet to the outlet flows over the wind turbine; wherein the configuration of the inlet portion to include a number of separate flow paths allow the inlet to be configured to include a plurality of flow paths each of which is profiled to cause, via a venturi effect, a decrease in static air pressure and consequently an increase in dynamic pressure and air velocity of air flowing towards the wind turbine; and wherein the plurality of flow paths allow the channel to include a plurality of venturis configured to focus the dynamic air pressure in front of the wind turbine to maximise the effect of the air velocity on the wind turbine.

Within the context of the specification and claims the term wind turbine refers to any type of wind turbine including, but not limited to, both vertical and horizontally mounted wind turbines.

The outlet also may have at least one guide vane so that the channel at the outlet portion is divided into a number of flow paths leading away from the wind turbine thereby assisting in reducing the static pressure in the outlet portion.

The intermediate portion may have a maximum cross sectional diameter and the inlet portion has a maximum cross sectional diameter which is at least twice the maximum cross sectional diameter of the intermediate portion so that a cross sectional diameter of the channel reduces from the inlet portion to the intermediate portion.

The outlet portion may have a maximum cross sectional diameter which is greater than the maximum cross sectional diameter of the intermediate portion so that the maximum cross sectional diameter of the channel increases from the intermediate portion to the outlet.

The maximum cross sectional diameter of the inlet portion may be in the order of between 2 to 4 times the maximum cross sectional diameter of the intermediate portion. In another example, the maximum cross sectional diameter of the inlet portion may be in the order of between 2 to 3 times the maximum cross sectional diameter of the intermediate portion.

The side wall may have an outer surface which is shaped to have, at least when viewed in plan, a curved profile so that the side wall curves inwardly towards the intermediate portion from the inlet portion and outwardly towards the outlet portion from the intermediate portion.

The side wall may be double walled; wherein the side wall has an outer surface which is shaped to have, at least when viewed in plan, a curved profile so that the side wall curves inwardly towards the intermediate portion from the inlet portion and outwardly towards the outlet portion from the intermediate portion; wherein the side wall may be double walled so that each side wall forms a venturi on either side of the channel extending through the body; and wherein the venturi on either side of the channel increases the velocity of air flowing on either side of the channel thereby during to cause air with an elevated velocity to be delivered adjacent to the outlet portion to assist with flow of air from the channel through the outlet portion.

In one example of the invention, the side wall may include an inner layer which defines the channel, and an outer layer which extends alongside the inner layer so that a flow passage is formed at least partly around the channel. The flow passage may have an inlet, an outlet and a maximum cross sectional diameter which reduces in size between the inlet and the outlet. The flow passage therefore may act as a venturi for air flowing through the flow passage.

The inner layer defining the outlet portion may be formed with one or more slots which allow air to pass from the channel to the flow passage.

The wind turbine may be a vertical mounted wind turbine and the channel may have a transverse dimension which is substantially equal to a height of the wind turbine.

The maximum cross sectional diameter of the intermediate section may be slightly larger than a maximum cross sectional diameter of the wind turbine.

The present invention also extends to a wind turbine air flow device which is capable of guiding the flow of air towards a wind turbine; the wind turbine air flow device includes a body having a front side, a rear side, an inner side wall which defines a channel which extends through the body, and an outer side wall which extends along the inner side wall so that a flow passage is formed between the inner and outer side walls; the at least one side wall having an inlet portion which defines an inlet to the channel, an outlet portion which defines an outlet from the channel, and an intermediate portion which lies between the inlet and outlet portions inside the channel; wherein in use the wind turbine is positioned inside the intermediate portion so that air passing through the channel from the inlet to the outlet flows past the wind turbine; wherein the inlet portion has at least one guide vane so that the channel at the inlet portion is divided into a number of flow paths leading towards the wind turbine each of which causes a decrease in static pressure and consequently an increase in dynamic pressure and in velocity of air flowing through a venturi towards the wind turbine; wherein the flow passage is profiled to form a venturi for air flowing through the flow passage towards the rear side of the body; and wherein the plurality of flow paths allow the channel to include a plurality of venturis configured to focus the dynamic air pressure in front of the wind turbine to maximise the effect of the air velocity on the wind turbine; whereby air exiting from the flow passages entrain at least partly the air exiting from the outlet of the channel.

The inner wall may have at least one slot formed through the inner wall thereby to allow air to pass from the channel into the flow passage.

The invention further extends to a method of guiding air flow relative to a wind turbine, the method including the steps of forming a first air flow channel having an inlet and an outlet and which increases a volumetric flow rate of air from the inlet towards the wind turbine and the outlet, and forming a second air flow channel which flows adjacent the first air flow channel and which increases the volumetric flow rate of air towards an outlet of the second air flow channel so that air flowing through the outlet of the second air flow channel entrains at least partly air flowing from the outlet of the first air flow channel.

In another form of the invention, there is also provided for a method of guiding air flow relative to a wind turbine, the method including the steps of forming a first air flow channel having an inlet and an outlet and which increases a volumetric flow rate of air from the inlet towards the wind turbine and the outlet, forming a second air flow channel which flows adjacent the first air flow channel and which increases the volumetric flow rate of air towards an outlet of the second air flow channel so that air flowing through the outlet of the second air flow channel entrains at least partly air flowing from the outlet of the first air flow channel; and forming a number of flow paths inside the inlet by positioning a number of guide vane at least partly inside the inlet of the first airflow channel thereby to cause, via a venturi effect, a decrease in static air pressure and consequently an increase in dynamic air pressure and in a velocity of air flowing towards a wind turbine which is positioned inside the first airflow channel so that the plurality of flow paths allow the channel to include a plurality of venturis configured to focus the dynamic air pressure in front of the wind turbine to maximise the effect of the air velocity on the wind turbine.

In a further form, the invention also extends to a wind turbine air flow device when used devices the flow of air relative to a wind turbine; the wind turbine air flow device includes a body having a side wall which defines a plurality of channels which extends into the body for fluid communication with to a central passage; each of the plurality of channels having an inlet portion which defines an inlet to the channel and an outlet portion which defines an outlet from the channel; at least one of the plurality of channels has at least one guide vane so that the respective channel at the inlet portion is divided into a number of flow paths leading towards the wind turbine and across one or more blades of the wind turbine thereby to cause rotational of the wind turbine about a longitudinal axis of the wind turbine; wherein in use the wind turbine is positioned inside the central passage so that air passing through at least one of the plurality of channels through the inlet and from the outlet flows into the wind turbine; wherein each flow path and channel is profiled to cause, via a venturi effect, a decrease in air pressure and an increase in air velocity of air flowing towards the wind turbine; wherein the wind turbine includes a central tubular passage which is configured to allow air flowing into the wind turbine to flow into the central tubular passage; and wherein the central tubular passage includes an impeller which is rotated through concentric rotation of the wind turbine thereby to cause air flowing into the central tubular passage to be pushed through and out of the central tubular passage thereby to assist in movement of air through the body.

The central passage may be formed by a central void or tube which extends longitudinally through the wind turbine.

An impeller may be positioned inside the central passage; and wherein the rotational movement of the wind turbine causes rotational movement of the impeller thereby driving air away from the impeller through the central passage thereby to assist in movement of air through the body.

An impeller may be positioned inside the central passage; and wherein the impeller is loosely fitted inside the central passage for rotational movement independent of rotational movement of the wind turbine; and wherein rotational movement of the impeller causes air to be driven away from the impeller through the central passage thereby to assist in movement of air through the body.

The impeller may have an upper surface and a lower surface; and wherein both surfaces includes grooves which are configured to cause movement of air away from the impeller; and wherein the impeller is positioned inside the central passage intermediate to the wind turbine thereby causing air to move in opposite directions away from impeller inside the central passage.

The wind turbine airflow device may include a second body to which is mounted a second wind turbine; wherein the first and second bodies are positioned adjacent each other thereby allowing the impeller to be connected to the second wind turbine; and wherein rotational movement of the second wind turbine causes rotational movement of the impeller thereby to drive air through the central passage of the first wind turbine.

In another form, the present invention also extends to a wind turbine air flow device which is capable of guiding the flow of air towards and across a horizontal axis wind turbine; the wind turbine air flow device includes a body having a front side, a rear side, and a side wall which defines a channel which extends through the body and at least one flow passage which extends at a position in between the front and rear sides through the sidewall and into the channel; the channel including an inlet portion which defines an inlet to the channel, an outlet portion which defines an outlet from the channel, and an intermediate portion which lies between the inlet and outlet portions inside the channel and into which the at least one flow passage extends; wherein the horizontal axis wind turbine is mounted for rotation about a longitudinal axis inside the channel so that air passing through the channel from the inlet to the outlet flows past the wind turbine thereby to cause rotational movement of the horizontal axis wind turbine about the longitudinal axis; wherein the horizontal axis wind turbine includes a central portion which projects at each end of the horizontal axis wind turbine into at least the inlet portion thereby to form a guide vane in the inlet portion; wherein the guide vane causes the channel at the inlet portion to be divided into a number of flow paths leading towards the wind turbine with each of the number of flow paths forming a venturi thereby to cause a decrease in static pressure and consequently an increase in dynamic pressure and in velocity of air flowing towards the wind turbine; wherein the at least one flow passage is profiled to form a venturi for air flowing through the flow passage towards the channel thereby causing air with an increased velocity to be introduced into the channel in between the inlet and outlet portions to assist with air moving through the channel over the horizontal axis wind turbine.

### BRIEF DESCRIPTION OF THE DRAWINGS

In order that the invention can be more readily understood one or more embodiments of the invention are further described by way of example with reference to the accompanying drawings.

FIG. 1 is a perspective view showing a schematic representation of a wind turbine air flow device according to the invention.

FIG. 2 is a plan view of the wind turbine air flow device of FIG. 1.

FIG. 3 is a plan view showing a schematic representation of a variation of a wind turbine airflow device according to the invention and which is used with two vertical wind turbines.

FIG. 4 is a plan view showing a schematic representation of a further variation of a wind turbine airflow device according to the invention.

FIG. 5 is a perspective view showing the wind turbine airflow device of FIG. 4, in addition to another small turbine powering the impeller which is mounted to a central passage of the wind turbine shown in FIG. 4.

FIG. 6 is a perspective view showing a schematic representation of another variation of a wind turbine airflow device according to the invention.

### DESCRIPTION OF ILLUSTRATED EMBODIMENT OF THE INVENTION

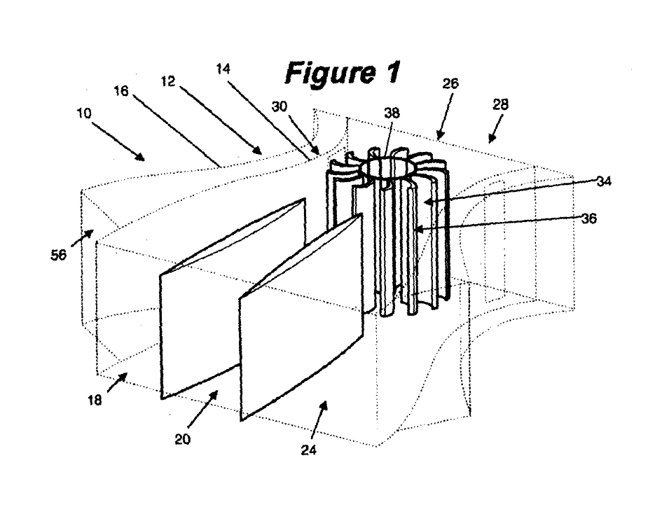

FIG. 1 of the accompanying illustrations shows a wind turbine air flow device 10 according to the principles of the invention. The wind turbine airflow device has a body 12 having an inner side wall 14 and an outer side wall 16. The inner side wall defines a channel 18 which extends through the body. Also defined by the inner side wall is an inlet portion 20 which defines an inlet 24 to the channel, an outlet portion 26 which defines an outlet 28 from the channel, and an intermediate portion 30 which is positioned between the inlet and outlet portions.

Positioned inside the intermediate portion is a vertical axis wind turbine 34. The wind turbine 34 has a number of blades 36 which extend from a central core 38 of the wind turbine.

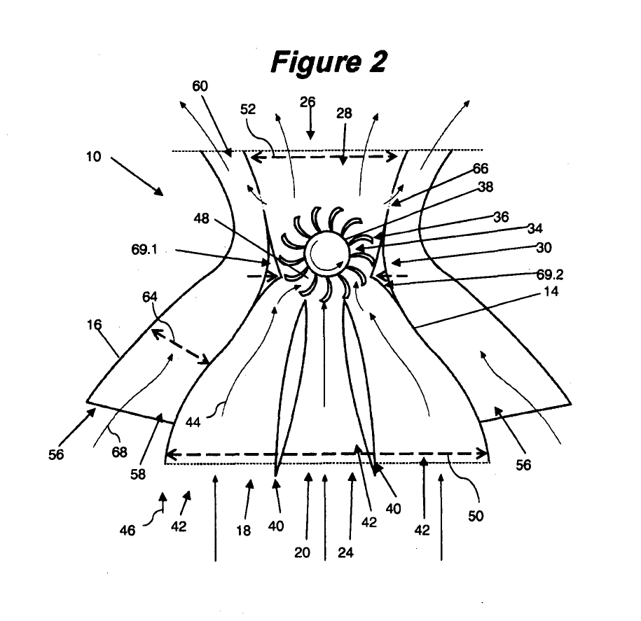

Referring to FIG. 2, the inlet portion 20 has two guide vanes 40 which extend into the channel 18 from the inlet 24. The guide vanes 40 divide the channel 18 at the inlet portion 20 into a number of Venturi flow paths 42 which devices a portion 44 of wind or air 46 towards the vertical axis wind turbine 34. The plurality of flow paths allow the channel to include a plurality of venturis configured to focus the dynamic air pressure in front of the wind turbine to maximise the effect of the air velocity on the wind turbine.

The intermediate portion 30 has a maximum cross sectional diameter 48. The inlet portion 20 has a maximum cross sectional diameter 50 which is in the order of between 2 to 3 times greater than the maximum cross sectional diameter 48 of the intermediate portion. Additionally, the outlet 28 has a maximum cross sectional diameter 52 which is greater than the maximum cross sectional diameter 48 of the intermediate portion. Typically the maximum cross-sectional diameter 52 is in the order of around 1.5 times that of the maximum cross sectional diameter 48 of the intermediate portion. Thus, the profiling or shape of the inner wall 14 causes the channel 18 to narrow towards the intermediate portion from the inlet 24 and thereafter to widen from the intermediate portion to the outlet 28. This narrowing of the channel results in the increase in air velocity towards the vertical axis wind turbine 34 while the widening of the channel causes a low pressure area to be formed in the outlet portion. The Venturi effect is therefore utilized in order to increase the velocity of the portion 44 of the air 46 flowing through the channel.

However, the dividing of the channel 18 at the inlet portion 20 into a number of flow paths 42 each of which substantially creates a venturi effect inside the channel. The increase in the number of venturis formed inside the channel promotes the further decrease of air pressure towards the intermediate portion thereby promoting the further increase in velocity of the portion 44 of the air 46 flowing through the channel as a result of the Venturi effect.

The outer side wall 16 extends alongside the inner side wall 14 thereby to create a flow passage 56 on either side of the channel 18. Each of the flow passages 56 has an inlet 58 and an outlet 60. Each of the flow passages 56 is further profiled so that a cross sectional diameter 64 of the flow passages 56 reduces from the inlet 58 to the outlet 60. The inner side wall 14 further includes a slot 66 on either side of the channel 18 which allows air to be exchanged between the channel 18 and the flow passages 56. The slots 66 may be further profiled in order to promote air moving from the channel to either of the flow passages 56.

When calculating pressure values of a fluid system, for example such as air passing through a wind turbine airflow device or stator 10, one type of equation which can be used is that of Bernoulli. Using Bernoulli's equation, the total pressure in the stator 10 is taken to remain constant throughout the fluid system. However, the static pressure is taken to decrease and, conversely, the dynamic pressure is taken to increase equally in the intermediate portion or constriction 30. But, Bernoulli's equation is for incompressible fluids and air is not specifically an incompressible fluid, although, in fluid dynamics, compressible fluid can be defined as the described hereinbelow.

Generally speaking compressible flow can be taken to describe the behaviour of fluids that experience significant variations in density. For flows in which the density does not vary significantly, the analysis of the behaviour of such flows may be simplified greatly by assuming a constant density. This is a postulation which leads to the theory of incompressible flow. However, in the many cases dealing with fluids such as gases (especially at higher velocities) and those cases dealing with liquids with large pressure changes, significant variations in density can occur. Consequently such a fluid flow should be analysed as a compressible flow to assist in obtaining more accurate results.

As a general rule of thumb, if the change in density relative to a stagnation density of a particular fluid is greater than 5%, then the fluid most likely should be analysed as a compressible flow. Furthermore, it is generally taken that an ideal gas (air) will have a ratio of specific heats in the order of 1.4 when a fluid has a velocity at a Mach number greater than approximately 0.3. However, generally speaking for fluid flows having a velocity below this value often a deciding factor, during calculation when deciding whether or not the fluid should be treated as a compressible or as an incompressible fluid, depends largely on the level of accuracy that is required during application of Bernoulli's equation.

However, in the stator 10, it is unlikely for the air speed to reach Mach 0.3 (approx. 100 m/s), so it can be assumed, for the present illustrated example and for simplification, that air is an incompressible flow. But in doing so, we have to assume a constant density. In actuality, the change in density in the constriction 30 will increase as the velocity of the air increases, but this change most likely will not be all very large.

The real power output for any energy conversion device in a free-flowing fluid stream can be expressed as P=½*C*n*p*A*v̂3, where P=power, C=thrust coefficient, n=mechanical/electrical efficiency, p=air density, A=area covered by turbine blades and v=wind velocity. One of the key factors in the formula is the velocity at which the wind hits the turbine since velocity in the power output equation is cubed (v̂3).

Referring in particular to FIGS. 1 and 2, similarly to wind speed increases between buildings or in tunnels, where via the Venturi Effect, air is essentially compressed in order to allow flow through the constriction. When this happens, static pressure in the tunnel decreases and the wind velocity increases. Preliminary research has revealed that the wind speed can be increased by a factor of between 2-3. This means, the velocity of the wind hitting the turbine blades 36 could be 2-3 times greater than ambient velocities. Reverting back to the Power equation, therefore assuming an ambient speed of 1 m/s, the factor v̂3 will be 1 as 1×1×1=1. The Venturi effect could result in an increase in the wind speed by a factor of 2 thereby increasing the factor v̂3 of the portion 44 inside the intermediate portion 30 by a factor of 8, as 2×2×2=8. Optimistically then an increased velocity factor of 3 would result in the factor v̂3 inside the channel 18 to be increased by a factor of 27, as 3×3×3=27. Thus, if velocity inside of the portion 44 inside the intermediate portion is increased by a factor of between 2 and 3, assuming all things being equal except velocity, as per the Power equation above, the resulting increase in potential power output will respectively be 8 times and 27 times greater than the power output when using only ambient wind speeds.

In light of the above, in use the portion 44 of the air 46 experiences a decrease in pressure, due to the reduction of the maximum cross sectional diameter 50 of the channel 18, as the portion 44 moves towards the vertical axis wind turbine 34. In other words, the static air pressure P will decrease towards the intermediate portion 30 with the dynamic air pressure, equating to ½ρν², increasing due to the increase in the velocity ν component. The reduction in pressure which the portion 44 of air experiences as the portion 44 moves through the channel 18 results in the velocity of the portion 44 to increase. Using the power output equation, ν is cubed so that the potential power output of a generator connected to the turbine via an axle, not shown, can be increased by a factor as much as 27 if the velocity is increased by a factor of 3 inside the intermediate portion 30.

As the portion 44 moves past the vertical axis wind turbine 34, some of the kinetic energy of the portion 44 is converted into rotational movement of the vertical axis wind turbine 34 through the blades 36. The rotational movement of the vertical axis wind turbine can then be used to generate electricity.

The loss in kinetic energy experienced by the portion 44 inside the channel 18 causes the portion 44 to experience a reduction in velocity in the outlet portion 26. However, the widening of the outlet portion assists in the movement of the portion 44 of air through the outlet portion 26. Typically the angle of the inner side wall 14 at the outlet portion 26, relative to a longitudinal central axis of the wind turbine airflow device, is in the order of between 5° to 10° thereby to provide the upper portion with a gradual increase in volume to assist in movement of the portion 44 through and out of the outlet 28.

Similarly, the inner side wall 14 at the inlet portion 20 is angled in the order of between 30° and 35°. The angles of the inner side wall 14 at the inlet portion 20 and the outlet portion 26 is suitably chosen to provide an optimal venturi effect inside the channel 18.

The flow of the portion 68 of the air 46 through the flow passages 56 is accelerated as the portion 68 moves towards the outlets 60 of the flow passages. This is due to the Venturi effect which the portion 68 experiences inside each of the flow passages 56. The increase in flow of the portion 68 will promote movement of the portion 44 of the air 46 through the outlet portion 26 as some of the air of the portion 44 is entrained by the flow of the portion 68 through the flow passages 56. Thus, some of the air of the portion 44 is drawn from the channel 18 into the flow passages 56 through the slots 66. Movement of the portion 44 through the flow passages 56 could assist in decreasing the pressure of the portion 44 inside the outlet portion 26 which in turn could assist in movement of the portion through the channel 18.

The widening of the outlet portion 26 further promotes the movement of the portion 44 through the channel 18. Furthermore, the assistance in movement of the portion 44 inside the outlet portion 26 may further reduce the likelihood of the portion 44, having reduced kinetic energy and therefore a reduced velocity, from presenting a form of back pressure which restricts movement of air of the portion 44 from the inlet portion 20 to the outlet portion 26.

Referring in particular to FIG. 2, a guide block 69 is positioned inside the intermediate portion 30 on either side of the wind turbine 34. The guide blocks 69 are designed to direct the flow of the portion 44 of air onto the wind turbine in such a way to promote rotational movement of the wind turbine. Furthermore, the guide block 69.1 guides the portion 44 to flow away from the side wall 14. This reduces the likelihood of the portion 44 flowing onto the rear surfaces of the blades 36 which could reduce the rotational speed of the wind turbine. Similarly, the guide block 69.2 guides the portion 44 away from the side wall and onto the blades 36. It should be noted that the guide block 69.2 could be profiled so that an upper end of the guide block does not extend as far into the channel 18. This should allow the portion 44 to be guided more towards the outlet 28 and as a result into the blades 36.

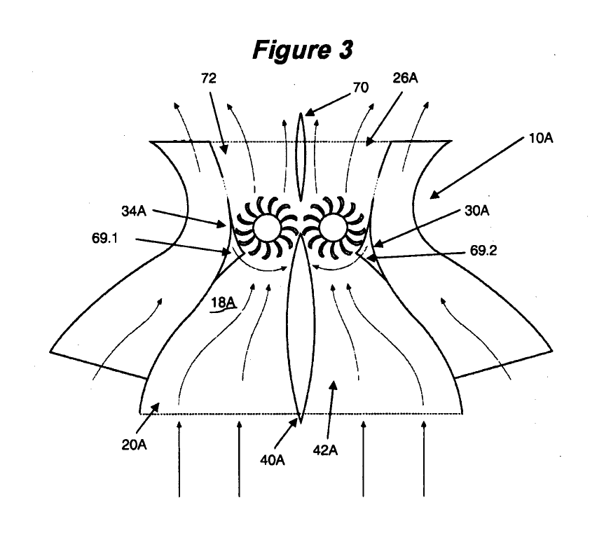

FIG. 3 illustrates a variation 10A of the invention. Like reference numerals are used to designate like components between the wind turbine air flow devices 10 and 10A. The wind turbine air flow device 10A includes two vertical axis wind turbines 34A which are mounted inside an intermediate portion 30A. An inlet portion 20A includes one guide vane 40A which divides a channel 18A into two flow paths 42A. However, an outlet portion 26A also includes a guide vane 70 which divides the channel 18A in the outlet portion into a number of exit flow paths 72. The increase in number of exit flow paths serves to promote the flow of air through the outlet portion.

The guide vane 40A promotes the separation of air flowing towards the two vertical axis wind turbines 34A thereby to reduce the likelihood of the operation of either of the vertical axis wind turbines impacting negatively on the other of the vertical axis wind turbines. Additionally, each of the vertical axis wind turbines 34A may rotate in an opposite direction relatively to the other thereby reducing the likelihood of rotational movement in either of the two vertical axis wind turbines from impacting negatively on the wind stream of the other vertical axis wind turbine.

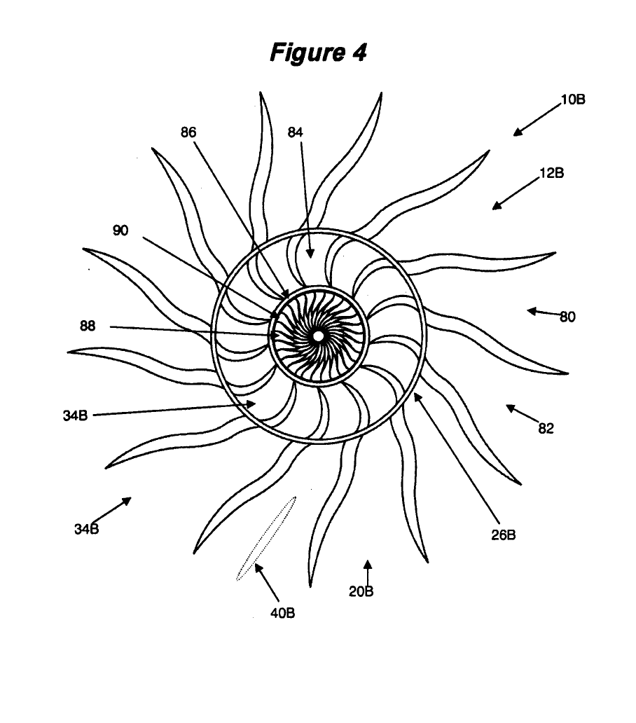

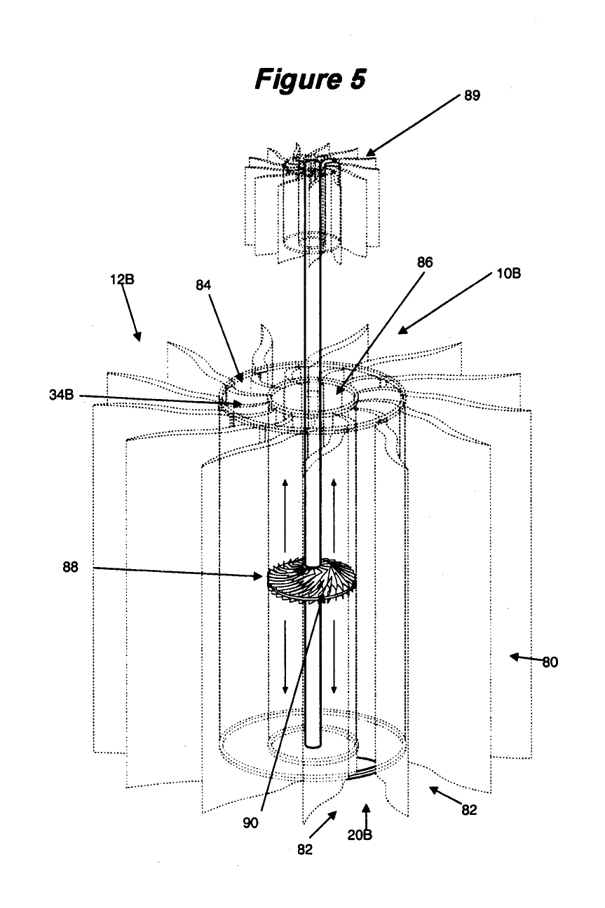

FIGS. 4 and 5 illustrate a further variation 10B of a wind turbine airflow device according to the principles of the invention. Like reference levels are used to designate like components between the wind turbine airflow devices 10 and 10B.

The wind turbine air flow device 10B includes a body 12B having a side wall 80 which defines a plurality of channels 82 each of which extends into the body for fluid communication with a central passage 84. Each of the plurality of channels has an inlet portion 20B, which defines an inlet 24B to the channel, and an outlet portion 26B which defines an outlet 28B from the channel.

At least one of the plurality of channels 82 has at least one device vane 40B so that the respective channel at the inlet portion 20B is divided into a number of flow paths leading towards a vertical axis wind turbine 34B. It should be noted that the number of device vanes may be omitted if required.

In use the wind turbine 34B is positioned inside the central passage 84 so that air passing through at least one of the plurality of channels 82 through the respective inlet and out of the outlet flows into the wind turbine and across one or more blades 36B of the wind turbine thereby to cause rotational of the wind turbine about a longitudinal axis of the wind turbine. Each flow path and channel is profiled to cause, via a venturi effect, a decrease in air pressure and an increase in air velocity of air flowing towards the wind turbine.

The wind turbine 34B includes a central tubular passage 86 which is configured to allow air flowing into the wind turbine to flow into the central tubular passage. Mounted inside the central tubular passage is an impeller 88. The impeller is connected to the wind turbine so that rotational movement of the wind turbine causes concentric rotation of the wind turbine. Rotational movement of the impeller causes air flowing into the central tubular passage to be pushed through and out of the central tubular passage thereby to assist in movement of air through the body 12B. The impeller has grooves on either side thereby allowing the impeller to be mounted halfway inside the central tubular passage 86 so that operation of the impeller causes air to be pushed in both directions. Thus, the impeller is positioned inside the central tubular passage so that air is pushed upwardly and downwardly from the central tubular passage, thereby reducing that distance exiting air has to travel.

The wind turbine airflow guide device 10B may further include a second body 89 to which is mounted a second wind turbine. The second wind turbine is connected with a shaft to the impeller 88 thereby allowing rotational movement of the second wind turbine to cause rotational movement of the impeller 88 which is loosely fitted inside the central tubular passage 86 for rotational movement independently of the first wind turbine. This allows rotational movement of the second wind turbine to be used to drive the impeller.

It should be noted that the shape of the blades may be altered so that the blades are configured to extract energy from air that has passed into the central tubular passage and which is flowing through the central tubular passage due to rotational movement of the impeller. Thus, the blades are designed to allow movement of air caused through operation of the impeller, to act on the blades to assist in causing rotational movement of the wind turbine.

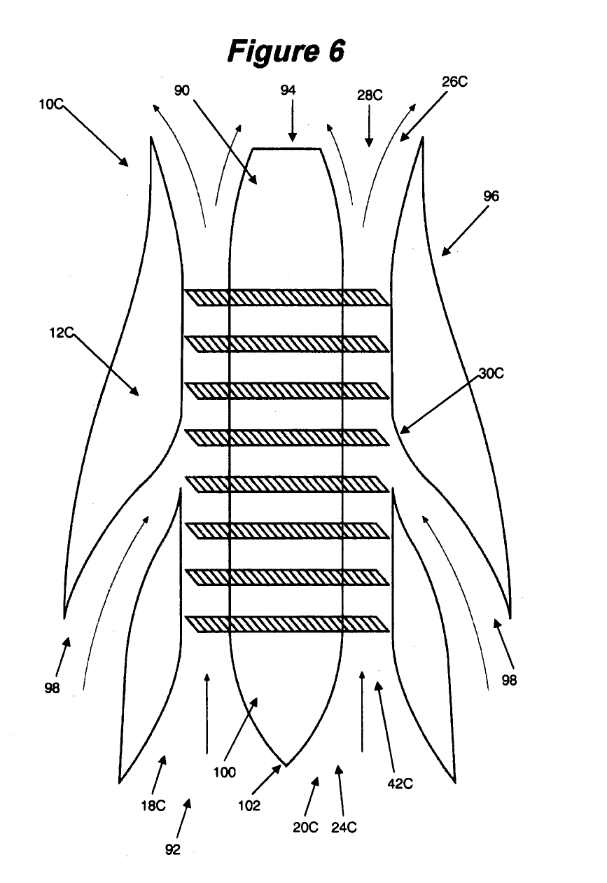

FIG. 6 shows another variation 10C of a wind turbine airflow device according to the principles of the invention. Like reference numerals are used to designate like components between the wind turbine airflow devices 10 and 10C.

The wind turbine air flow device 10C is used to device the flow of air towards and across a horizontal axis wind turbine 90. The wind turbine air flow device includes a body 12C having a front side 92, a rear side 94, and a side wall 96 which defines a channel 18C which extends through the body and at least one flow passage 98 which extends at a position in between the front and rear sides through the sidewall and into the channel.

The channel 18C includes an inlet portion 20C which defines an inlet 24C, an outlet portion 26C which defines an outlet 28C from the channel, and an intermediate portion 30C which lies between the inlet and outlet portions inside the channel and into which the at least one flow passage extends.

The horizontal axis wind turbine 90 is mounted for rotation about a longitudinal axis inside the channel 18C so that air passing through the channel from the inlet to the outlet flows past the wind turbine thereby to cause rotational movement of the horizontal axis wind turbine about the longitudinal axis. The horizontal axis wind turbine includes a central portion 100 which projects at each end of the horizontal axis wind turbine into the inlet and outlet portions 20C and 24C thereby to form guide vane 102 in the portions. P

The guide vane 102 cause the channel at the inlet portion 20C to be divided into a number of flow paths 42C leading towards the wind turbine with each of the number of flow paths forming a venturi thereby to cause a decrease in pressure and an increase in velocity of air flowing towards the wind turbine.

The flow passages 98 are profiled to form a venturi for air flowing through the flow passage towards the channel thereby causing air with an increased velocity to be introduced into the channel 18C in between the inlet and outlet portions 20C and 24C to assist with air moving through the channel over the horizontal axis wind turbine.

It should be noted that dimensions of the inlet 24 of the channel 18 will depend on the size of the wind turbines used inside the air flow device. The curvatures of the inner and outer side walls 14 and 16 will be dependent on the number and size of the wind turbines used with the air flow device of the invention. Furthermore, a mounting mechanism may be used to align the inlet relative to the movement of the air 46 thereby to promote correctly aligning the inlet so that the air 46 can flow through the channel 18. For example, the air flow device me be supported on a magnetic levitation system, not shown.

The air flow device of the present invention therefore focuses on concentrating air energy in front of a wind turbine while promoting the exiting of air from the flow device.

The invention therefore could provide an air flow device for wind turbines which includes a number of flow paths which assist in the movement of air through the air flow device which assists in increasing the efficiency and power output of the wind turbine. The air flow device includes flow passages alongside a central channel which houses the wind turbine. The flow passages and the channel are shaped in order to promote movement of air through the flow passages and channel using a Venturi effect. The flow passages are connected with the channel downstream from the wind turbine thereby to promote movement of air through the channel until exiting the air flow device. The movement of air through the channel downstream from the wind turbine assists in maintaining a low pressure downstream from the wind turbine thereby promoting movement of air upstream from the wind turbine to the downstream area of the air flow device.

The airflow device of the present invention also could provide a vertical axis wind turbine which includes a centrally mounted impeller which rotates concentrically with rotational movement of the vertical axis wind turbine thereby to push air through a central tubular passage of the vertical axis wind turbine.

A number of flow paths are formed inside the inlet by positioning a number of guide vane at least partly inside the inlet of the first airflow channel thereby to cause, via a venturi effect, a decrease in static air pressure and consequently an increasing dynamic air pressure and in a velocity of air flowing towards a wind turbine which is positioned inside the first airflow channel so that the plurality of flow paths allow the channel to include a plurality of venturis configured to focus the dynamic air pressure in front of the wind turbine to maximise the effect of the air velocity on the wind turbine.

The airflow device of the present invention could furthermore provides one or more flow passages which are positioned relative to a channel containing a horizontal axis wind turbine thereby to introduce air of which a velocity has been increased at an intermediate portion of the channel thereby to assist in air moving through the channel.

While we have described herein a particular embodiment of a wind turbine air flow device, it is further envisaged that other embodiments of the invention could exhibit any number and combination of any one of the features previously described. However, it is to be understood that any variations and modifications which can be made without departing from the spirit and scope thereof are included into the scope of the invention.

1. A wind turbine air flow device for use to guide the flow of air relative to a wind turbine; the wind turbine air flow device includes a body having at least one side wall which defines a channel which extends through the body; and the at least one side wall having an inlet portion which defines an inlet to the channel, an outlet portion which defines an outlet from the channel, and an intermediate portion which lies between the inlet and outlet portions inside the channel; wherein the inlet portion has at least one device vane so that the channel at the inlet portion is divided into a number of flow paths leading towards the wind turbine; wherein in use the wind turbine is positioned inside the intermediate portion so that air passing through the channel from the inlet to the outlet flows over the wind turbine; wherein the plurality of channel flow paths are configured to focus the air pressure in front of the wind turbine to improve the effect of the air velocity on the wind turbine.

2. A wind turbine air flow device according to claim 1 wherein the configuration of the inlet portion to include a number of separate flow paths each of which is profiled to cause, via a venturi effect, a decrease in static air pressure and consequently an increase in dynamic pressure and air velocity of air flowing towards the wind turbine; and wherein the channel flow paths focuses the dynamic air pressure in front of the wind turbine.

3. A wind turbine airflow device according to claim 1 wherein the outlet includes at least one guide vane so that the channel at the outlet portion is divided into a number of flow paths leading away from the wind turbine thereby assisting in reducing the static pressure in the outlet portion.

4. A wind turbine airflow device according to claim 1 wherein the intermediate portion has a maximum cross sectional diameter and the inlet portion has a maximum cross sectional diameter which is at least twice the maximum cross sectional diameter of the intermediate portion so that a cross sectional diameter of the channel reduces from the inlet portion to the intermediate portion to form the Venturi effect towards the wind turbine.

5. A wind turbine airflow device according to claim 1 wherein the outlet portion has a maximum cross sectional diameter which is greater than the maximum cross sectional diameter of the intermediate portion so that the maximum cross sectional diameter of the channel increases from the intermediate portion to the outlet.

6. A wind turbine airflow device according to claim 5 wherein the maximum cross sectional diameter of the inlet portion is selected from a value in the range of between 2 to 4 times the maximum cross sectional diameter of the intermediate portion.

7. A wind turbine airflow device according to claim 6 wherein the maximum cross sectional diameter of the inlet portion is selected from a value in the range of between 2 to 3 times the maximum cross sectional diameter of the intermediate portion.

8. A wind turbine airflow device according to claim 1 wherein the side wall has an outer surface which is shaped to have, at least when viewed in plan, a curved profile so that the side wall curves inwardly towards the intermediate portion from the inlet portion and outwardly towards the outlet portion from the intermediate portion; wherein the side wall may be double walled so that each side wall forms a venturi on either side of the channel extending through the body; and wherein the venturi on either side of the channel increases the velocity of air flowing on either side of the channel thereby during to cause air with an elevated velocity to be delivered adjacent to the outlet portion to assist with flow of air from the channel through the outlet portion.

9. A wind turbine airflow device according to claim 8 wherein the side wall includes an inner layer which defines the channel, and an outer layer which extends alongside the inner layer so that a flow passage is formed at least partly around the channel.

10. A wind turbine airflow device according to claim 9 wherein each of the flow passages on either side of the channel has an inlet, an outlet and a maximum cross sectional diameter which reduces in size between the inlet and the outlet.

11. A wind turbine airflow device according to claim 10 wherein an intermediate portion of each of the flow passages has a maximum cross-sectional diameter which is less than the maximum cross sectional diameter of the outlet so that each of the flow passages narrows from the inlet to the intermediate portion and widens from intermediate portion to the outlet.

12. A wind turbine airflow device according to claim 10 wherein the inner layer defining the outlet portion is formed with at least one slot which allow air to pass from the channel to the flow passage thereby to cause air passing through the channel to being entrained with air passing through either of the flow passages.

13. A wind turbine airflow device according to claim 1 wherein the wind turbine is a vertical mounted wind turbine and the channel may have a transverse dimension which is substantially equal to a height of the wind turbine; and the maximum cross sectional diameter of the intermediate section is slightly larger than the maximum cross sectional diameter of the wind turbine.

14. A wind turbine air flow device which is capable of guiding the flow of air towards a wind turbine; the wind turbine air flow device includes a body having a front side, a rear side, an inner side wall which defines a channel which extends through the body, and an outer side wall which extends along the inner side wall; the at least one side wall having an inlet portion which defines an inlet to the channel, an outlet portion which defines an outlet from the channel, and an intermediate portion which lies between the inlet and outlet portions inside the channel; the outer sidewall is profiled so that a flow passage is formed between the inner and outer side walls adjacent the channel; wherein in use the wind turbine is positioned inside the intermediate portion so that air passing through the channel from the inlet to the outlet flows past the wind turbine; wherein the inlet portion has at least one guide vane so that the channel at the inlet portion is divided into a number of flow paths leading towards the wind turbine each of which causes a decrease in static pressure and an increase in velocity of air flowing through a venturi towards the wind turbine; wherein the flow passage on either side of the channel is profiled to form a venturi for air flowing through the flow passage towards the rear side of the body; and wherein the plurality of flow paths allow the channel to include a plurality of venturis configured to focus the dynamic air pressure in front of the wind turbine to maximise the effect of the air velocity on the wind turbine; whereby air exiting from the flow passages entrain at least partly the air exiting from the outlet of the channel thereby to assist air moving from the outlet portion.

15. A wind turbine airflow device according to claim 14 wherein the inner wall includes at least one slot formed through the inner wall thereby to allow air to pass from the channel into the flow passage inside the outlet portion thereby to cause air to move from the channel in the outlet portion into the flow passages to assist air from moving from the outlet portion.

16. A method of guiding air flow relative to a wind turbine, the method including the steps of forming a first air flow channel having an inlet and an outlet and which increases a volumetric flow rate of air from the inlet towards the wind turbine and the outlet, forming a second air flow channel which flows adjacent the first air flow channel and which increases the volumetric flow rate of air towards an outlet of the second air flow channel so that air flowing through the outlet of the second air flow channel entrains at least partly air flowing from the outlet of the first air flow channel; and forming a number of flow paths inside the inlet by positioning a number of guide vane at least partly inside the inlet of the first airflow channel thereby to cause, via a venturi effect, a decrease in static air pressure and consequently an increase in dynamic air pressure and in velocity of air flowing towards a wind turbine which is positioned inside the first airflow channel so that the plurality of flow paths allow the channel to include a plurality of venturis configured to focus the dynamic air pressure in front of the wind turbine to maximise the effect of the air velocity on the wind turbine.

17. A wind turbine air flow device for use to guide the flow of air relative to a wind turbine; the wind turbine air flow device includes a body having a side wall which defines a plurality of channels which extends into the body for fluid communication with a central passage; each of the plurality of channels having an inlet portion which defines an inlet to the channel and an outlet portion which defines an outlet from the channel; at least one of the plurality of channels has at least one guide vane so that the respective channel at the inlet portion is divided into a number of flow paths leading towards the wind turbine; wherein in use the wind turbine is positioned inside the central passage so that air passing through at least one of the plurality of channels through the inlet and from the outlet flows into the wind turbine and across one or more blades of the wind turbine thereby to cause rotational of the wind turbine about a longitudinal axis of the wind turbine; wherein each flow path and channel is profiled to cause, via a venturi effect, a decrease in air pressure and an increase in air velocity of air flowing towards the wind turbine; wherein the wind turbine includes a central tubular passage which is configured to allow air flowing into the wind turbine to flow into the central tubular passage; and wherein the central tubular passage includes an impeller which is rotated through concentric rotation of the wind turbine thereby to cause air flowing into the central tubular passage to be pushed through and out of the central tubular passage thereby to assist in movement of air through the body.

18. A wind turbine airflow device according to claim 17 wherein an impeller is positioned inside the central passage; and wherein the rotational movement of the wind turbine causes rotational movement of the impeller thereby driving air away from the impeller through the central passage thereby to assist in movement of air through the body.

19. A wind turbine airflow device according to claim 18 wherein an impeller is positioned inside the central passage; wherein the impeller is loosely fitted inside the central passage for rotational movement independent of rotational movement of the wind turbine; and wherein rotational movement of the impeller causes air to be driven away from the impeller through the central passage thereby to assist in movement of air through the body.

20. A wind turbine airflow device according to claim 18 wherein the impeller includes an upper surface and a lower surface; and wherein both surfaces includes grooves which are configured to cause movement of air away from the impeller; and wherein the impeller is positioned inside the central passage intermediate to the wind turbine thereby causing air to move in opposite directions away from impeller inside the central passage.

21. A wind turbine airflow device according to claim 17 which includes a second body to which is mounted a second wind turbine; wherein the first and second bodies are positioned adjacent each other thereby allowing the impeller to be connected to the second wind turbine; and wherein rotational movement of the second wind turbine causes rotational movement of the impeller thereby to drive air through the central passage of the first wind turbine.

22. A wind turbine air flow device which is capable of guiding the flow of air towards and across a horizontal axis wind turbine; the wind turbine air flow device includes a body having a front side, a rear side, and a side wall which defines a channel which extends through the body and at least one flow passage which extends at a position in between the front and rear sides through the sidewall and into the channel; the channel including an inlet portion which defines an inlet to the channel, an outlet portion which defines an outlet from the channel, and an intermediate portion which lies between the inlet and outlet portions inside the channel and into which the at least one flow passage extends; wherein the horizontal axis wind turbine is mounted for rotation about a longitudinal axis inside the channel so that air passing through the channel from the inlet to the outlet flows past the wind turbine thereby to cause rotational movement of the horizontal axis wind turbine about the longitudinal axis; wherein the horizontal axis wind turbine includes a central portion which projects at each end of the horizontal axis wind turbine into at least the inlet portion thereby to form a guide vane in the inlet portion; wherein the guide vane causes the channel at the inlet portion to be divided into a number of flow paths leading towards the wind turbine with each of the number of flow paths forming a venturi thereby to cause a decrease in static pressure and consequently an increase in dynamic pressure and in velocity of air flowing towards the wind turbine; wherein the at least one flow passage is profiled to form a venturi for air flowing through the flow passage towards the channel thereby causing air with an increased velocity to be introduced into the channel in between the inlet and outlet portions to assist with air moving through the channel over the horizontal axis wind turbine.

23-24. (canceled)
